(19) United States
(12) Patent Application Publication
(10) Pub. No.: US 2026/0177894 A1
(43) Pub. Date: Jun. 25, 2026

(54) PHOTOGRAPHIC EQUIPMENT MOUNTING BRACKET AND PHOTOGRAPHIC KIT

(71) Applicant: TILTA INC., Burbank, CA (US)

(72) Inventors: Sen WU, Shenzhen (CN); Hong ZHANG, Shenzhen (CN); Wenping ZENG, Shenzhen (CN); Kefeng ZHOU, Shenzhen (CN)

(21) Appl. No.: 19/430,895

(22) Filed: Dec. 23, 2025

(30) Foreign Application Priority Data
Dec. 24, 2024 (CN) 202423235891.7

(51) Int. Cl. G03B 17/56; F16M 11/12; G06F 1/16

(52) U.S. Cl. CPC G03B 17/561; F16M 11/126; G03B 17/566; G06F 1/1601

(57) ABSTRACT

A photographic equipment mounting bracket includes a bracket body, a threaded connector, and two positioning members. The threaded connector is movably positioned on the bracket body and is designed for threaded connection with a threaded interface of photographic equipment. Both positioning members are embedded on the same side of the bracket body and are distributed circumferentially around the threaded connector. In the radial direction of the threaded connector, the respective distances between the central axes of the two positioning members and the central axis of the threaded connector are different. The two positioning members can selectively engage and fit with a corresponding positioning hole on the photographic equipment via the movable part of one of the positioning members.

### CROSS-REFERENCE TO RELATED APPLICATIONS

The present application for patent claims priority to and the benefit of pending Chinese Application No. 202423235891.7, filed Dec. 24, 2024, and hereby expressly incorporated by reference herein as if fully set forth below in its entirety and for all applicable purposes.

### TECHNICAL FIELD

The present disclosure pertains to the field of photographic equipment, and specifically, to a photographic equipment mounting bracket and a photographic kit.

### INTRODUCTION

With economic growth, smartphones and camera equipment have become increasingly prevalent, leading to the flourishing of industries such as photography, videography, and live streaming. In daily life, a growing number of individuals are developing a passion for photography, resulting in the creation of a lot of photographic accessories. Typically, photographic equipment is equipped with interfaces for connecting various external accessories. Common interfaces include cold shoes, hot shoes, industrial standard rails (e.g., NATO rails), cranksets, and threaded interfaces, facilitating the mounting of photographic equipment and its connection/fixation to external accessories.

The manner in which photographic equipment is mounted remains an important and widely encountered concern. In the field, bracket-type auxiliary tools are frequently employed for mounting and fixing photographic equipment. However, photographic equipment on the market may feature interfaces of varying specifications. Consequently, existing mounting brackets generally struggle to accommodate photographic equipment with different interface structures and designs, presenting certain usage limitations. The aforementioned issue represents a technical challenge that urgently requires resolution in the field.

### BRIEF SUMMARY

Aspects of the present disclosure provide a photographic equipment mounting bracket and a photographic kit, wherein the photographic equipment mounting bracket can establish connection and adaptation with photographic equipment having different interface structures.

In some aspects, the photographic equipment mounting bracket has a threaded connector that can be utilized to connect and fix photographic equipment with a threaded interface, thereby securing the photographic equipment to a bracket body of the photographic equipment mounting bracket. The photographic equipment mounting bracket has positioning members that can align and engage with positioning holes on the photographic equipment via their movable parts. After the threaded connector is connected and fixed to the photographic equipment, if the position of a positioning member does not align with the position of a positioning hole on the photographic equipment, the positioning member will be pressed down and retract under the influence of the photographic equipment, thereby not interfering with the assembly of the bracket body and the photographic equipment. Due to the differing distances between the central axes of the two positioning members and the central axis of the threaded connector—meaning the movable part of one positioning member is closer to the threaded connector, while the movable part of the other is farther away—the two positioning members are adapted to different photographic equipment. The two positioning members of this photographic equipment mounting bracket can be simultaneously pressed down, or one of them can align and engage with a positioning hole on the photographic equipment, achieving universality and compatibility with photographic equipment of different interface structures. This expands the applicable scope of the photographic equipment mounting bracket. Furthermore, under the combined action of the positioning members and the threaded connector, the photographic equipment can be stably fixed to the bracket body, effectively preventing positional movement and enhancing the practicality and stability of the photographic equipment mounting bracket.

### BRIEF DESCRIPTION OF THE DRAWINGS

FIG. 1 is a schematic diagram illustrating a photographic equipment mounting bracket according to some aspects of the disclosure.

FIG. 2 is a top view of the photographic equipment mounting bracket according to some aspects of the disclosure.

FIG. 3 is a sectional view taken along the line A-A in FIG. 2 according to some aspects of the disclosure.

FIG. 4 is an exploded schematic diagram of the photographic equipment mounting bracket in FIG. 1 according to some aspects of the disclosure.

FIG. 5 is a schematic diagram of an assembly of a base, a positioning member, and a gasket of FIG. 1 according to some aspects of the disclosure.

FIG. 6 is a top view the assembly of FIG. 5 according to some aspects of the disclosure.

FIG. 7 is a sectional view taken along the line B-B in FIG. 6 according to some aspects of the disclosure.

FIG. 8 is a partial exploded schematic diagram of the photographic equipment mounting bracket in FIG. 1 according to some aspects of the disclosure.

FIG. 9 is another perspective view of FIG. 8 according to some aspects of the disclosure.

FIG. 10 is a schematic diagram of a monitor mounted in the mounting base according to some aspects of the disclosure.

FIG. 11 is a schematic diagram of the monitor according to some aspects of the disclosure.

Reference Numerals: 100. Bracket body; 110. Mounting base; 111. Recessed groove; 112. First side wall; 113. Waist-type hole; 120. Base; 121. Functional hole; 122. Blind hole; 123. Protruding part; 124. Positioning bevel; 125. Annular groove; 130. Adjustment base; 140. Connecting arm; 141. External interface; 200. Threaded connector; 300. Positioning member; 310. Movable part; 311. Flange; 320. Fixed part; 330. Elastic member; 400. Gasket; 500. Photographic equipment mounting bracket; 510. Monitor; 520. Threaded interface; 530. positioning hole.

### DETAILED DESCRIPTION

Common photographic equipment on the market is equipped with interfaces for connecting various external accessories. These interfaces include, but are not limited to, cold shoes, hot shoes, industrial standard rails (e.g., NATO rails), cranksets, and threaded interfaces. Among these, threaded interfaces are widely utilized due to their simple structure and connection scheme. However, there are also various photographic equipment on the market that employ threaded interfaces for external connection. Some photographic equipment may only feature a threaded interface, while others may have positioning holes around the threaded interface. Furthermore, the specifications and dimensions of the positioning holes on photographic equipment may vary, and the distance between the positioning holes and the threaded interface can differ. Therefore, it is challenging for existing photographic equipment mounting brackets to accommodate these two distinct interface schemes employed by various photographic equipment. To address the aforementioned technical challenge, the present disclosure provides a photographic equipment mounting bracket and a photographic kit, which can achieve structural matching and connection fixation with photographic equipment of different interface structures via the photographic equipment mounting bracket.

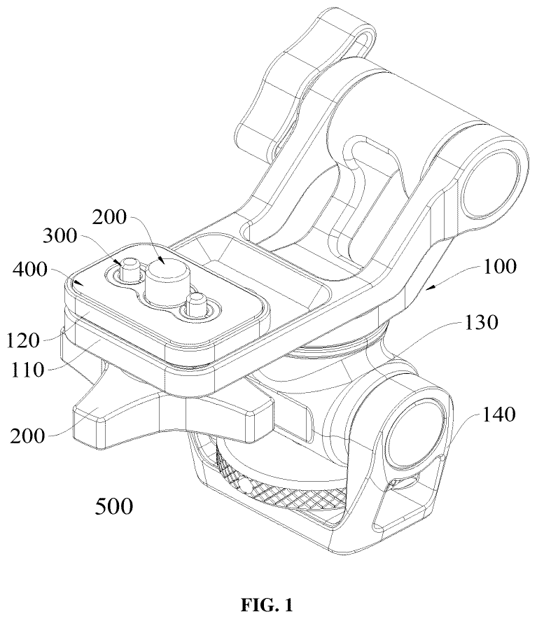

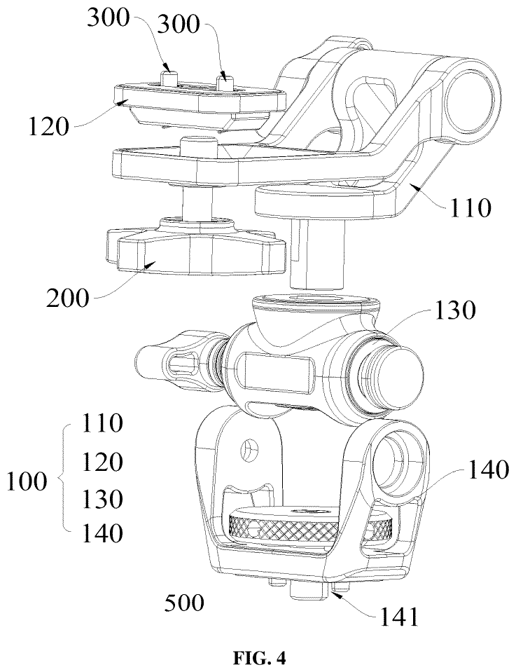

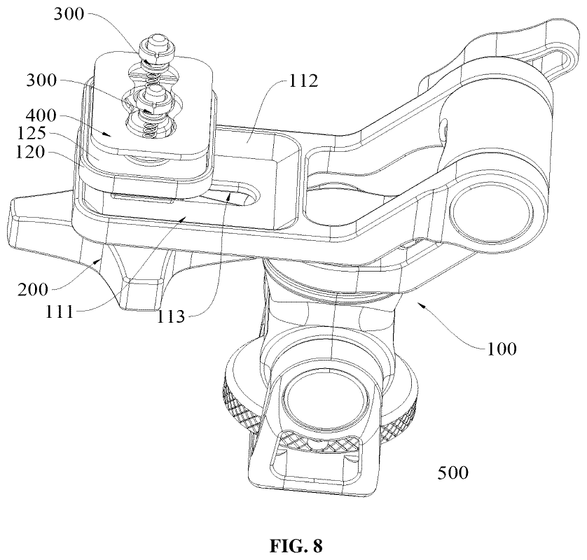

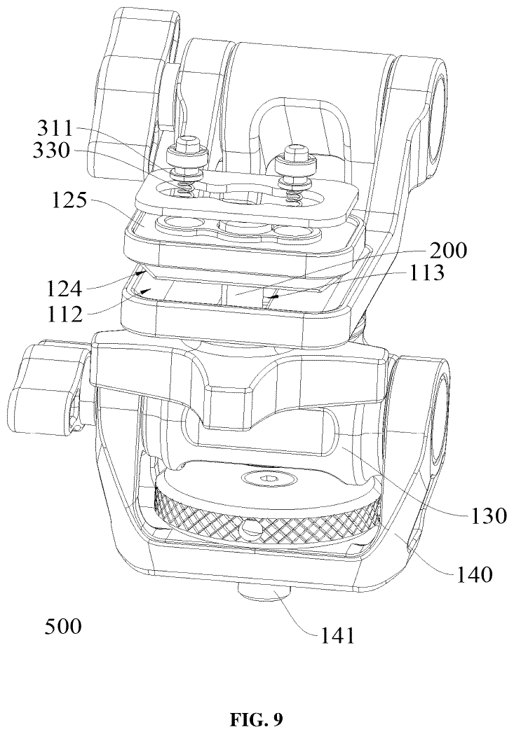

In some aspects, referring to FIGS. 1-11, a photographic equipment mounting bracket 500 includes a bracket body 100, a threaded connector 200, and two positioning members 300. The threaded connector 200 is movably positioned on the bracket body 100 and is designed for threaded connection with a threaded interface of photographic equipment. Both positioning members 300 are embedded on the same side of the bracket body 100 and are distributed circumferentially around (or on opposite sides of) the threaded connector 200. In the radial direction of the threaded connector 200, the distances between the central axes of the two positioning members 300 and the central axis of the threaded connector 200 are different. Each positioning member 300 includes a movable part 310. The movable part 310 protrudes from the surface of the bracket body 100 and can move relative to the bracket body 100 along the axial direction of the threaded connector 200 when pressed, enabling the two positioning members 300 to selectively engage and fit within a corresponding positioning hole on the photographic equipment via the movable part 310 of one of the positioning members 300. The bracket body 100 is connected and fixed to the photographic equipment via the threaded connector 200.

The photographic equipment mounting bracket 500 connects and fixes a photographic equipment with a threaded interface via the threaded connector 200, thereby securing the photographic equipment to the bracket body 100. Both positioning members 300 can engage with a compatible photographic equipment via their movable parts 310. For example, the movable part 310 is used to align and engage with a positioning hole on the photographic equipment. After the threaded connector 200 is connected and fixed to the photographic equipment, if the position of a positioning member 300 does not align with the position of a positioning hole on the photographic equipment, the positioning member 300 will be pressed down under the action of the photographic equipment, altering the length by which it protrudes from the surface of the bracket body 100. Due to the differing distances between the central axes of the two positioning members 300 and the central axis of the threaded connector 200—meaning the movable part 310 of one positioning member 300 is closer to the threaded connector 200, while the movable part 310 of the other is farther away—the two positioning members 300 are adapted to different photographic equipment. This enables the photographic equipment mounting bracket 500 to achieve positioning for two types of photographic equipment where the distances between the positioning hole and the threaded interface differ, simply by designing the spacing between the positioning members 300 and the threaded connector 200 to correspond to common specifications on the market. In some aspects, when mounting a photographic equipment, if the distance between the positioning hole on the photographic equipment and the threaded interface matches the distance between one of the positioning members 300 and the threaded connector 200, manual alignment of the positioning hole and that positioning member 300 can achieve their engagement. At this time, the other positioning member 300 will be pressed down by the photographic equipment due to misalignment with the positioning hole position and will not interfere with the assembly and fixation of the photographic equipment.

In some aspects, the photographic equipment mounting bracket 500 offers multiple usage scenarios. If the photographic equipment has no positioning holes or if the movable parts 310 of both positioning members 300 cannot align and engage with the positioning holes, both positioning members 300 of the mounting bracket 1000 can be simultaneously pressed down by the photographic equipment. In this scenario, the photographic equipment mounting bracket 500 only connects and fixes the photographic equipment via the threaded connector 200 and does not provide a positioning function for the photographic equipment. Alternatively, one of the two positioning members 300 can align and engage with a positioning hole on the photographic equipment. In some aspects, under the combined action of the threaded connector 200 and the positioning member 300, the photographic equipment mounting bracket 500 provides both connection and anti-shifting (e.g., anti-rotation) positioning for the photographic equipment, improving connection stability. This photographic equipment mounting bracket 500 can accommodate photographic equipment having different interface structures, thereby enhancing its universality and expanding its range of applicability. Furthermore, under the combined action of the positioning members 300 and the threaded connector 200, the photographic equipment can be stably fixed to the bracket body 100, effectively preventing positional movement and enhancing the practicality and stability of the photographic equipment mounting bracket 500.

The aforementioned “movable part 310 can move relative to the bracket body 100 along the axial direction of the threaded connector 200 when pressed down” can be implemented in various ways. For instance, in some examples, the moving direction of the movable part 310 can be directly parallel to the axial direction of the threaded connector 200, causing the dimension by which the movable part 310 protrudes from one surface of the bracket body 100 to gradually decrease. In some aspects, the movable part 310 may have a movement scheme with a component parallel to the axial direction of the threaded connector 200. That is, in its initial state, the movable part 310 protrudes from one surface of the bracket body 100. When pressed down, the movable part 310 moves towards the direction closer to the other surface of the bracket body 100, reducing the dimension by which it protrudes from the one surface. In this case, the movable part 310 has not only a movement component along the axial direction of the threaded connector 200 but also a movement component perpendicular to the axial direction of the threaded connector 200.

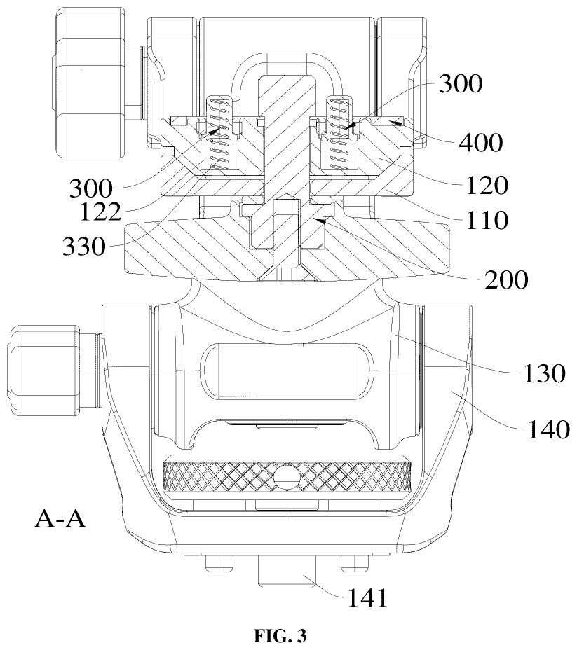

In some aspects, referring to FIGS. 3 and 5-9, each positioning member 300 further includes a connected fixed part 320 and an elastic member 330. The fixed part 320 is embedded in the bracket body 100. The positioning member 300 as a whole is installed and fixed on the bracket body 100 via the fixed part 320. The fixed part 320 is flush with or lower than the surface of the bracket body 100 to avoid installation interference with the photographic equipment. The fixed part 320 and the movable part 310 are movably engaged. The fixed part 320 and the movable part 310 are configured to move relative to one another. The first end of the elastic member 330 is connected to the fixed part 320 or the bracket body 100, and the second end is connected to the movable part 310. The movable part 310 is elastically arranged on the bracket body 100 via the fixed part 320 and the elastic member 330. The elastic member 330 is used to provide resetting force for the movable part 310, enabling the movable part 310 to remain protruding from the surface of the bracket body 100 when no external force is applied, so that the dimension by which the movable part 310 protrudes from the surface of the bracket body 100 can be adaptively changed. Additionally, “connected” herein encompasses direct connection/fixation as well as abutting and force transmission methods.

In some aspects, the positioning member 300 can be designed as a self-retractable structure. That is, both ends of the elastic member 330 are connected to the fixed part 320 and the movable part 310, respectively. Under the action of the elastic member 330, the movable part 310 can move relative to the fixed part 320 when force is applied and extends when no external force is applied, allowing the movable part 310 to protrude from the surface of the bracket body 100.

In some aspects, with reference to FIGS. 3 and 5-9, the bracket body 100 is equipped with two blind holes 122. Each of the two positioning members 300 is installed in a separate blind hole 122. The fixed part 320 is connected and secured to the wall of the blind hole 122. The fixed part 320 is fitted over the movable part 310. The first end of the elastic member 330 is either connected to or abuts against the bottom wall of the blind hole 122. The movable part 310 is elastically positioned inside the blind hole 122 via the fixed part 320 and the elastic member 330. The distances between the two blind holes 122 and the central axis of the threaded connector 200 correspond one-to-one with the distances between the two positioning members 300 and the central axis of the threaded connector 200. That is, the distances between the two blind holes 122 and the central axis of the threaded connector 200 are different, allowing the distances between the two positioning members 300 and the central axis of the threaded connector 200 to also be different.

The present disclosure does not limit the particular connection and fixation method between the fixed part 320 and the wall of the blind hole 122. For example, in some examples, a connection scheme involving an interference fit between a plain shaft structure on the fixed part 320 and a plain hole in the blind hole 122 may be employed. In other examples, a threaded connection may be used between the fixed part 320 and the blind hole 122 to ensure connection/fixation strength and reduce assembly difficulty.

In some aspects, the movable part 310 can be fitted over the fixed part 320. The assembly method and structure of the positioning member 300 can vary, and the present disclosure imposes no restrictions thereon, as long as the structural principle of the positioning member 300 is implemented, enabling the movable part 310 to be accommodated within the blind hole 122 when pressed down.

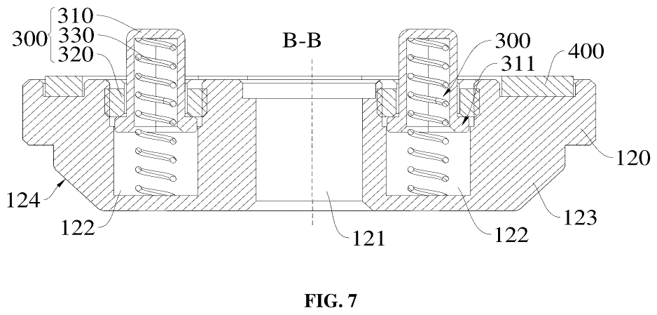

In some aspects, with reference to FIGS. 7-9, to prevent the movable part 310 from disengaging from the fixed part 320 under the action of the elastic member 330, an end of the movable part 310 closer to the bottom wall of the blind hole 122 may be provided with a flange 311. The movable part 310 slidably cooperates with the blind hole 122 via the flange 311. The outer diameter of the flange 311 is greater than the diameter of the central hole of the fixed part 320. The flange 311 is located between the fixed part 320 and the bottom wall of the blind hole 122. The movable part 310 and the fixed part 320 are in limited engagement via the flange 311, thereby achieving bidirectional limitation of the movable part 310 through the bottom wall of the blind hole 122 and the flange 311, defining the maximum movement range of the movable part 310.

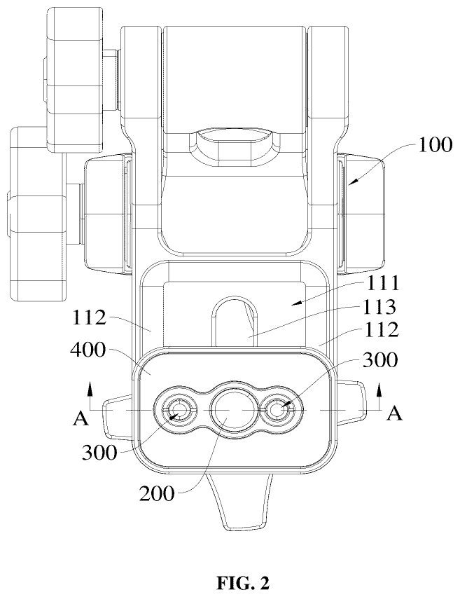

The present disclosure does not specifically restrict the distribution of the threaded connector 200 and the two positioning members 300, as long as the respective distances between the two positioning members 300 and the central axis of the threaded connector 200 are different. In some examples, with reference to FIGS. 1 and 2, in the radial direction of the threaded connector 200, the two positioning members 300 are distributed on opposite sides of the threaded connector 200. This arrangement is beneficial for the gravity center distribution of the photographic equipment mounting bracket 500 and helps enhance its stability.

In some aspects, with reference to FIGS. 1, 2, 6, and 7, the two positioning members 300 are distributed on opposite sides of the threaded connector 200 along the same diameter direction of the threaded connector 200. In other words, the central axis of the threaded connector 200 lies on the line connecting the central axes of the two positioning members 300. This arrangement maximally addresses the issue of center of gravity offset caused by asymmetric installation of the two positioning members 300, further enhancing the stability of the photographic equipment mounting bracket 500.

In some aspects, a gasket 400 can be placed on the side surface of the bracket body 100 where the two positioning members 300 are installed, to further stably place and support the photographic equipment.

In some aspects, with reference to FIGS. 1-9, the bracket body 100 includes a mounting base 110 and a base 120. The base 120 is detachably installed on the mounting base 110 and is positioned in cooperation with the mounting base 110. Both positioning members 300 are embedded on the same side of the base 120. The threaded connector 200 is movably arranged on the mounting base 110. The base 120 has a functional hole 121 through which the threaded connector 200 passes. Consequently, the base 120 and the two positioning members 300 can be pre-manufactured as an integrated structure or component, and then the base 120 with the positioning members 300 installed can be placed onto the mounting base 110. When applying this photographic equipment mounting bracket 500 to photographic equipment without positioning holes, the user can, according to needs, either assemble the base 120 or remove it, without interfering with the connection between the threaded connector 200 and the photographic equipment. This design gives the photographic equipment mounting bracket 500 of the present disclosure multiple configurations, providing users with more choices and offering high practicality and compatibility.

In some aspects, with reference to FIGS. 1-4, to simplify the detachable connection scheme between the base 120 and the mounting base 110, a recessed groove 111 is formed on the end surface of the mounting base 110. The threaded connector 200 is movably arranged on the bottom wall of the recessed groove 111. To stably position the base 120 on the mounting base 110, the recessed groove 111 has two opposite first side walls 112. Both of the first side walls 112 are inclined. In the direction of the opening of the recessed groove 111, the distance between the two first side walls 112 gradually increases. The ends of the two first side walls 112 connected to the bottom wall are close to each other, while the ends corresponding to the opening are divergent from each other. Two opposite ends of the base 120 are respectively provided with positioning bevels 124. The two positioning bevels 124 are located on the side of the base 120 opposite to the positioning members 300. The two positioning bevels 124 are used to respectively align and cooperate with the two first side walls 112. In other words, the bottom wall of the recessed groove 111 and the two first side walls 112 form a funnel-shaped space. The recessed groove 111 and the base 120 cooperate through matching inclined surfaces, serving to support and position the base 120. After the threaded connector 200 tightens the mounting base 110 and the photographic equipment, the base 120 and the mounting base 110 are pressed tightly together through the inclined surface structure. The base 120 is stably clamped between the mounting base 110 and the photographic equipment, enhancing the installation stability of the photographic equipment mounting bracket 500.

In some aspects, with reference to FIGS. 1-5, the side of the base 120 opposite to the positioning members 300 has a protruding part 123. The positioning bevels 124 are located at the two opposite ends of the protruding part 123.

The photographic equipment mounting bracket 500 of the present disclosure can adapt to photographic equipment whose interface structure includes both a threaded interface 2 and positioning holes. The application does not limit the positioning scheme among the functional hole 121 of the base 120, the two positioning members 300, the mounting base 110, and the threaded connector 200. As long as their positions, once determined, satisfy that the two positioning members 300 are distributed circumferentially around the threaded connector 200 and the distances between the central axes of the two positioning members 300 and the central axis of the threaded connector 200 are different.

In some examples, to simplify the assembly scheme and keep the relative positions between the two positioning members 300 and the threaded connector 200 unchanged, the functional hole 121 may be a plain hole or a threaded hole matching the size of the threaded connector 200. The threaded connector 200 passes through the bottom wall of the recessed groove 111 and is threadedly connected to it for installation of the threaded connector 200, preventing it from disengaging from the mounting base 110 and keeping its position on the mounting base 110 unchanged. In this case, the relative position between the threaded connector 200 and the mounting base 110 is fixed. Then, by correspondingly positioning the relative positions of the mounting base 110 and the base 120, the two positioning members 300 can be distributed circumferentially around the threaded connector 200.

In some aspects, with reference to FIGS. 2, 5, and 6, the functional hole 121 can be a threaded hole. The mounting base 110 further has a waist-type hole 113 penetrating through the bottom wall of the recessed groove 111. When the base 120 is installed in the recessed groove 111, the threaded connector 200 can pass through the waist-type hole 113 to threadedly connect with the base 120. The assembly of the positioning members 300 and the threaded connector 200 can be adjusted in position along the length direction of the waist-type hole 113 (e.g., a slot), facilitating adaptation to photographic equipment of different sizes and adjustment of the position between the photographic equipment mounting bracket 500 and the photographic equipment. This allows adjustment of the position where the center of gravity of the photographic equipment falls on the mounting base 110, ensuring stable installation of the photographic equipment on the photographic equipment mounting bracket 500 and effectively enhancing its adjustability and practicality.

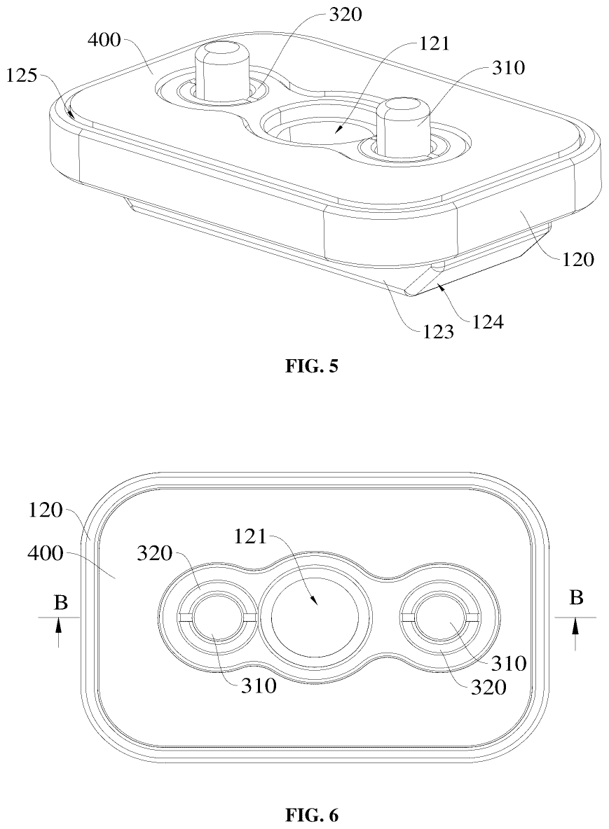

In some aspects, with reference to FIGS. 5, 8, and 9, an annular groove 125 is further provided on the end surface of the base 120 where the two positioning members 300 are situated, for the purpose of stably supporting the photographic equipment. The threaded connector 200 and the two positioning members 300 are all spaced from the annular groove 125 and are positioned within the inner circle of the annular groove 125. The photographic equipment mounting bracket 500 further includes a flexible gasket 400. The flexible gasket 400 is installed within the annular groove 125 to stably mount and support the photographic equipment while effectively mitigating wear between the base 120 and the photographic equipment.

In some aspects, with reference to FIGS. 1-5, to facilitate comprehensive adjustment of the photographic equipment and the bracket body 100, the bracket body 100 further includes an adjustment base 130 and a connecting arm 140. One end of the adjustment base 130 is adjustably and rotatably connected to the mounting base 110 about a first rotation axis. The other end of the adjustment base 130 is adjustably and rotatably connected to the connecting arm 140 about a second rotation axis, enabling rotational adjustment in the horizontal plane and tilt angle adjustment. In some examples, the overall cooperation scheme and principle of the adjustment base 130 and the connecting arm 140 can be analogous to the structure and principle of a worm head. As worm heads are part of prior art solutions, they are not elaborated upon here.

In some aspects, with reference to FIGS. 1-4, the end of the connecting arm 140 opposite to the adjustment base 130 is further equipped with an external interface 141. The external interface 141 can be a cold shoe mount, a NATO rail, or a threaded fastener. Consequently, connection of the mounting bracket to another external device can be achieved through the external interface 141. External devices include, but are not limited to, cameras, camera cages, and mobile phones.

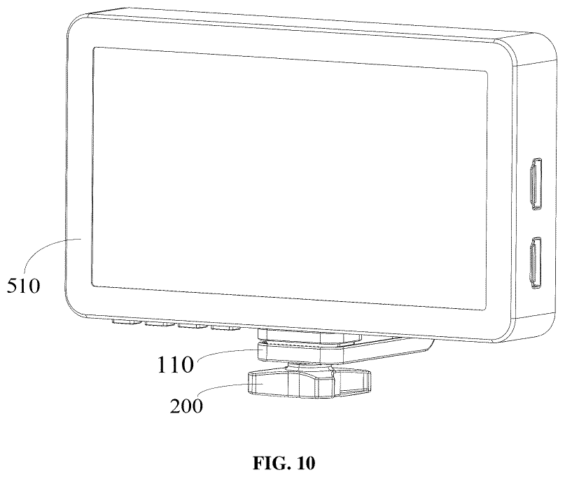

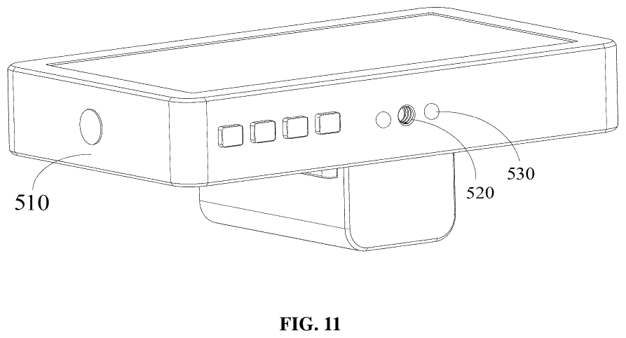

Based on the same inventive concept, with reference to FIGS. 10 and 11, the present disclosure further discloses a photographic kit including a monitor 510 and the photographic equipment mounting bracket 500 described in the aforementioned embodiments. The monitor 510, a type of photographic equipment, features either a threaded interface 520 or both a threaded interface 520 and positioning holes 530. The photographic equipment mounting bracket 500 is selectively connected and fixed to the monitor 510 at least through the threaded connector 200. In other words, this photographic kit can encompass multiple matching schemes. The monitor 510 may have a design with only a threaded interface 520, or it may have a design with both a threaded interface 520 and positioning holes 530. However, since the photographic mounting bracket is equipped with two positioning members 300 at different distances from the threaded connector 200, and the positioning members 300 can move relative to the bracket body 100 when subjected to pressure along the axial direction of the threaded connector, this does not affect the assembly of the photographic equipment with the bracket body 100. Thus, compatibility and adaptation can be achieved, allowing for various structural configurations of the monitor 510 in front-end production and manufacturing, which is beneficial for enhancing the overall performance of the product.

In summary, the photographic equipment mounting bracket 500 and photographic kit provided by the present disclosure offer at least the following effects:

The photographic equipment mounting bracket 500 can connect and secure photographic equipment with a threaded interface 520 via the threaded connector 200, thereby firmly attaching the photographic equipment to the bracket body 100. The movable part 310 is employed to align and engage with a positioning hole on the photographic equipment. After the threaded connector 200 is connected and fixed to the photographic equipment, if the position of a positioning member 300 does not align with the position of a positioning hole on the photographic equipment, the positioning member 300 will be pressed down under the action of the photographic equipment, so as not to interfere with the assembly of the bracket body and the photographic equipment. Because the distances between the respective central axes of the two positioning members 300 and the central axis of the threaded connector 200 are different—meaning the movable part 310 of one positioning member 300 is closer to the threaded connector 200, while the movable part 310 of the other is farther away—the two positioning members 300 are adapted to different photographic equipment. The two positioning members 300 of this photographic equipment mounting bracket 500 can be simultaneously pressed down, or one of them can align and engage with a positioning hole on the photographic equipment, achieving versatility and compatibility with photographic equipment of different interface structures. This expands the applicable scope of the photographic equipment mounting bracket 500. Furthermore, under the combined action of the positioning members 300 and the threaded connector 200, the photographic equipment can be stably fixed to the bracket body 100, effectively preventing positional movement and enhancing the practicality and stability of the photographic equipment mounting bracket 500.

The above descriptions represent exemplary embodiments of the present disclosure and are not intended to limit the scope of the present disclosure. Any modifications, equivalent replacements, and improvements made within the spirit and principles of the present disclosure shall be included within the protection scope of the present disclosure.

What is claimed is:

1. A photographic equipment mounting bracket, comprising:
a bracket body;
a threaded connector movably disposed on the bracket body, wherein the threaded connector is configured for threaded engagement with a threaded interface of a photographic equipment, to connect and secure the photographic equipment to the bracket body via the threaded connector; and
two positioning members, wherein both of the two positioning members are embedded on a same side of the bracket body, and the two positioning members are distributed circumferentially around the threaded connector; and wherein, along a radial direction of the threaded connector, a distance between a central axis of one of the two positioning members and a central axis of the threaded connector differs from a distance between a central axis of another one of the two positioning members and the central axis of the threaded connector;
wherein each of the two positioning members comprises a movable part protruding from a surface of the bracket body, and the movable part is configured to move relative to the bracket body along an axial direction of the threaded connector in response to being pressed down, thereby enabling engagement of one movable part of the two positioning members with a corresponding positioning hole on the photographic equipment.

2. The photographic equipment mounting bracket according to claim 1, wherein each of the two positioning members further comprises a fixed part and an elastic member;
wherein the fixed part is embedded in the bracket body and is flush with or below the surface of the bracket body;
wherein the fixed part is movably engaged with the movable part;
wherein a first end of the elastic member is connected to the fixed part or the bracket body;
wherein a second end of the elastic member is connected to the movable part; and
wherein the movable part is elastically disposed on the bracket body via the fixed part and the elastic member.

3. The photographic equipment mounting bracket according to claim 2, wherein the bracket body is provided with two blind holes;
wherein the two positioning members are respectively installed in the two blind holes;
wherein the fixed part is fixedly connected to a hole wall of a corresponding blind hole;
wherein the fixed part is sleeved outside the movable part;
wherein the first end of the elastic member is connected to or abuts against a bottom wall of the corresponding blind hole; and
wherein the movable part is elastically disposed inside the corresponding blind hole via the fixed part and the elastic member.

4. The photographic equipment mounting bracket according to claim 3, wherein an end of the movable part proximate to the bottom wall of the corresponding blind hole is provided with a flange;
wherein the movable part slidably engages with the corresponding blind hole via the flange;
wherein an outer diameter dimension of the flange is greater than a diameter dimension of a central hole of the fixed part;
wherein the flange is located between the fixed part and the bottom wall of the corresponding blind hole; and
wherein the movable part and the fixed part are in limited-position engagement via the flange.

5. The photographic equipment mounting bracket according to claim 1, wherein, along the radial direction of the threaded connector, the two positioning members are distributed on opposite sides of the threaded connector.

6. The photographic equipment mounting bracket according to claim 1, wherein the bracket body comprises a mounting base and a base;
wherein the base is detachably installed on the mounting base and positioned in engagement with the mounting base;
wherein both of the two positioning members are embedded on a same side of the base;
wherein the threaded connector is movably disposed on the mounting base; and
wherein the base is provided with a functional hole allowing the threaded connector to pass through.

7. The photographic equipment mounting bracket according to claim 6, wherein an end face of the mounting base is formed with a recessed groove;
wherein the threaded connector is movably disposed on a bottom wall of the recessed groove;
wherein the recessed groove is provided with two opposite first side walls;
wherein both of the two first side walls are inclined;
wherein, along an opening direction of the recessed groove, a distance between the two first side walls gradually increases, with ends of the two first side walls connected to the bottom wall being closer to each other and ends of the two first side walls corresponding to the opening being farther apart from each other;
wherein two opposite ends of the base are respectively provided with a positioning bevel;
wherein the two positioning bevels are located on a side of the base opposite to the positioning members; and
wherein the two positioning bevels are configured for one-to-one alignment engagement with the two first side walls, respectively.

8. The photographic equipment mounting bracket according to claim 7, wherein the functional hole comprises a threaded hole;
wherein the mounting base is further configured with a waist-type hole penetrating through the bottom wall of the recessed groove;
wherein in response to the base being installed in the recessed groove, the threaded connector is configured to pass through the waist-type hole to threadedly connect with the base; and
wherein the positioning members and the threaded connector as a whole are adjustable in position along a length direction of the waist-type hole.

9. The photographic equipment mounting bracket according to claim 1, wherein an end face of the bracket body provided with the two positioning members is further provided with an annular groove;
wherein the threaded connector and the two positioning members are all spaced apart from the annular groove and located within an inner circle of the annular groove; and
wherein the photographic equipment mounting bracket further comprises a flexible gasket installed in the annular groove.

10. A photographic kit, comprising a monitor and the photographic equipment mounting bracket according to claim 1;
wherein the monitor is provided with a threaded interface, or the monitor is provided with a threaded interface and a positioning hole; and
wherein the photographic equipment mounting bracket is selectively connected and secured to the monitor at least via the threaded connector.
